(19) United States
(12) Patent Application Publication
(10) Pub. No.: US 2025/0046195 A1
(43) Pub. Date: Feb. 6, 2025

(54) SYSTEM FOR GENERATING UNIQUE NAVIGATIONAL INPUT FOR AN AIR-BORNE VEHICLE, AND A METHOD TEHREOF

(71) Applicant: Raziel Ella, Jerusalem (IL)

(72) Inventor: Raziel Ella, Jerusalem (IL)

(21) Appl. No.: 18/363,657

(22) Filed: Aug. 1, 2023

(51) Int. Cl. G08G 5/00

(52) U.S. Cl. CPC G08G 5/0026; G08G 5/0013; G08G 5/0082

(57) ABSTRACT

There is disclosed a system for generating at least one unique navigational input for one or more air-borne vehicle, wherein the system comprises: at least one server arrangement communicably coupled to an application module via a data communication network; at least one database arrangement communicably coupled with the server arrangement and the application module; wherein the server arrangement is configured to: receive at least one flight request from at least one user via the application module; generate at least one unique navigational input, upon receiving the at least one flight request from the user, based on at least one factor using an artificial intelligence module; wherein the server arrangement is configured to respond to at least one flight request received from the at least one user, by sending the at least one generated unique navigational input to the application module.

### FIELD OF INVENTION

In general, the present invention relates to the field of air traffic control. In particular, the present disclosure relates to a system and method for generating a safe, and efficient navigational route for plurality of air-borne vehicles.

### BACKGROUND

As air traffic continues to increase, air traffic control faces several challenges and problems. The key issues that arose were; Congestion: The sheer volume of aircraft in the sky can lead to congestion, especially in busy airspaces and airports. Air traffic controllers are required to efficiently manage the flow of aircraft to prevent delays and maintain safety; Communication overload: With more aircraft communicating with air traffic control, there can be an increased risk of miscommunication or radio congestion. It becomes crucial for controllers and pilots to effectively exchange information to ensure accurate instructions and clearances; Complexity: As air traffic becomes more complex, with various types of aircraft and flight operations, controllers must handle diverse situations simultaneously; Safety risks: With increased air traffic, there is a higher potential for safety incidents, including near misses or collisions. Controllers must remain vigilant and implement strict procedures to maintain safe separation between aircraft; Staffing and training: The demand for qualified air traffic controllers may outpace the availability of trained personnel. It takes time to train controllers with the necessary skills and experience to handle the growing air traffic. Staffing shortages can put additional pressure on existing controllers and may lead to fatigue and decreased performance; Weather disruptions: Adverse weather conditions can disrupt air traffic patterns, leading to delays and diversions. Air traffic controllers must manage the flow of aircraft during these situations and ensure the safety of all flights. This complexity can strain the capacity of air traffic control systems and require advanced tools and technologies to manage the workload effectively.

Addressing the aforementioned challenges requires a combination of technological advancements, improved procedures, increased staffing, and infrastructure investments. Governments, aviation authorities, and industry stakeholders continually work together to enhance air traffic control systems and ensure safe and efficient management of increasing air traffic.

In the recent past, the emerging technologies has played a crucial role in managing heavy air traffic by improving the efficiency and safety of air traffic control. Furthermore, the Radar technology has been a fundamental tool in air traffic control for many years. It allows controllers to track aircraft positions, detect potential conflicts, and provide guidance to pilots. Over time, radar systems have become more accurate and reliable. Furthermore, the Automated Dependent Surveillance-Broadcast (ADS-B) uses satellite-based navigation to provide real-time aircraft position information. It allows for more precise tracking of aircraft and enables controllers to have a better understanding of the airspace. ADS-B has improved surveillance capabilities and enhances situational awareness. Furthermore, the Data Communication (traditional voice communication) between controllers and pilots can be prone to errors and congestion. Data communication systems, such as Controller-Pilot Data Link Communications (CPDLC), enable the exchange of text-based messages between controllers and pilots. It reduces radio congestion, improves communication accuracy, and allows for more efficient information sharing. Furthermore, the Collaborative Decision Making (CDM) systems involve the sharing of data between air traffic control, airlines, and airports. It allows for better coordination and decision-making based on real-time information. CDM enhances the predictability of flights, reduces delays, and improves overall efficiency.

Furthermore, the Automation and Artificial Intelligence (AI) are increasingly being utilized in air traffic control systems. They can assist controllers in managing routine tasks, data processing, and decision support. Automated systems can help analyse large amounts of data and provide insights to enhance efficiency and safety.

Despite these technological advancements, there are some shortcomings and challenges associated with technology in managing heavy air traffic. Particularly, the Cost and Implementation: Implementing advanced air traffic control technologies can be expensive, requiring significant investments in infrastructure, equipment, and training. It can be a challenge to upgrade existing systems and ensure compatibility across different regions and countries; Integration and Compatibility: Coordinating different technologies and ensuring their compatibility can be complex, particularly when multiple systems need to interact seamlessly.

Integrating new technologies with existing infrastructure and ensuring interoperability can pose technical challenges; Cybersecurity Risks: As air traffic control systems become more interconnected and reliant on technology, cybersecurity threats become a concern. Safeguarding against potential cyber-attacks and ensuring the integrity of the systems is crucial to maintaining the safety and reliability of air traffic control; Human Factors and Training: While technology can assist in air traffic control, it cannot replace the expertise and judgment of human controllers. Adequate training and ongoing skill development are essential to ensure that controllers can effectively utilize technology and make critical decisions in complex situations; Reliance on Ground-Based Systems: Many air traffic control systems still rely on ground-based infrastructure, such as radar installations. This can limit coverage, especially in remote areas or over vast oceans. The development and implementation of satellite-based technologies can help overcome this limitation; Adaptation to Future Traffic Growth: As air traffic continues to increase, technology must keep pace with the growing demands. It requires ongoing research and development to develop advanced systems that can efficiently manage even heavier air traffic loads in the future.

Furthermore, the air traffic control as it today could never be able to handle a situation of a serious proliferation of flying vehicles. In fact, the existing method cannot control the situation even if the number of flying vehicles will be only 0.08% of the current number of cars on earth.

Thus, the invention as disclosed in the present disclosure aims to solve the problem of providing a unique navigational input for the plurality of air-borne vehicles. The invention as disclosed in the present disclosure further aims to solve the problem of providing a safe and efficient navigational input for the plurality of air-borne vehicle in real time.

Therefore, in light of the foregoing discussion, there exists a need to overcome the aforementioned drawbacks so as to provide a system configured to identify similar proteins.

### SUMMARY

An object of the present disclosure is to provide a smart, AI based system and application solution that will use AI modules for generating at least one unique, safe and efficient navigational flight paths for each air-borne vehicle.

Another object of the present invention is assigning at least one designated air space to each air-borne vehicle, defined by specific location and altitude which will be assigned based on the specified time on which the air-borne vehicle is expected to reach during its journey.

Another object of the present invention is predicting the at least one suitable emergency exit from the generated navigational flight paths for each air-borne vehicle.

Another object of the present invention is to consistently monitor and control the flight of all the air-borne vehicles, and ensure safety intervals of time and space between the air-borne vehicles.

In the first aspect, embodiments of the present disclosure provide a system for generating at least one unique navigational input for one or more air-borne vehicle, wherein the system comprises:
at least one server arrangement communicably coupled to an application module via a data communication network;
at least one database arrangement communicably coupled with the server arrangement and the application module;
   wherein the server arrangement is configured to:
receive at least one flight request from at least one user via the application module;
generate at least one unique navigational input, upon receiving the at least one flight request from the user, based on at least one factor using an artificial intelligence module;
   wherein the server arrangement is configured to predict at least one emergency exit input, based on the at least one parameter,
   wherein the server arrangement is configured to iteratively generate unique navigational input based on the at least one factor, to predict the emergency exit input having optimized combination of safety and speed, and
   wherein the server arrangement is configured to respond to at least one flight request received from the at least one user, by sending the at least one generated unique navigational input to the application module.

Optionally, the server arrangement is configured to predict at least one landing approach, as the unique navigational input for the at least one air-borne vehicle, using the artificial intelligence module.

Optionally, the application module is configured to locally store the generated unique navigational input in the database arrangement, and wherein the user has the access of the locally stored generated unique navigational input in case of lack of the communication network.

Optionally, the server arrangement is configured to update the generated navigational input in real time, based on air-traffic data.

Optionally, the server arrangement is configured to continuously monitor navigational data of the plurality of air-borne vehicles, wherein the server arrangement is configured to maintain the plurality of air-borne vehicles at a safe distance from each other.

Optionally, the server arrangement is configured to identify the unexpected change in the navigational data of the plurality of air-borne vehicles, and iteratively alter the navigational input for the at least one air-borne vehicle to generate a safe navigational input for the at least one air-borne vehicle, in real time.

Optionally, the server arrangement is configured to identify the at least one air-borne vehicle which is disconnected from the communication network, wherein the server arrangement is configured to alter the generated navigational input for the at-least one air-borne vehicle which is connected to the communication network, such that the disconnected air-borne vehicle will continue to use their current navigational input without clashing with other air-borne vehicles.

Optionally, the server arrangement is communicably coupled with a supervision module via the data communication network, wherein the supervision module is configured to identify at last one anomaly pertaining to the at least one air-borne vehicle which requires at least one input from another user, and wherein the supervision module is configured to analyse the navigational data of at least one air-borne vehicle, and identify the at least one anomaly using the artificial intelligence module, in real time.

Optionally, the server arrangement is configured to identify at least one fuel station based on the generated unique navigational input for the one or more air-borne vehicle, wherein the server arrangement utilizes the artificial intelligence module to identify the nearest fuel station to ensure that the one or more air-borne vehicle receives fuel timely, and wherein the server arrangement is configured to manage at least one in-air waiting areas, based on congestion of air-traffic on the identified at least one fuel station.

Optionally, the server arrangement is configured to facilitate the aerial fueling of the one or more air-borne vehicle based on the generated unique navigational input.

Optionally, the server arrangement is configured to identify at least one designated waiting area on ground for the one or more air-borne vehicle which were not able to perform aerial refuelling.

Optionally, the server arrangement is configured to create at least one alert to point-out deviations of the one or more air-borne vehicle from the generated at least one unique navigational input to a third party, by using the artificial intelligence module, wherein the created at least one alert comprises at least one of: a data pack of relevant information, a potential flight path, and an emergency communication.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

A better understanding of the present invention may be obtained through the following examples which are set forth to illustrate but are not to be construed as limiting the present invention.

### BRIEF DESCRIPTION OF DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for generating at least one unique navigational input for one or more air-borne vehicle;

FIG. 2 is a schematic illustration of an arrangement comprising the system for generating at least one unique navigational input for one or more air-borne vehicle in communication with an airborne vehicle;

FIG. 3 is a schematic illustration of an arrangement comprising the system for generating at least one unique navigational input for one or more air-borne vehicle in communication with an airborne vehicle, and in communication with a third party (air traffic control).

FIG. 4 is a schematic illustration of an arrangement comprising the system for generating at least one unique navigational input for one or more air-borne vehicle in communication with the airborne vehicle and in communication with the third party (air traffic control), and in communication with an air borne vehicle configured for aerial refuelling.

FIG. 5 is a schematic illustration of an arrangement comprising the system for generating at least one unique navigational input for one or more air-borne vehicle in communication with the airborne vehicle and in communication with the Supervision Desk Application.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated line, the non-underlined number is used to identify a general item to which the line is pointing.

### DETAILED DESCRIPTION

The following detailed description illustrates embodiments of the present disclosure and ways in which they can be implemented. Although some modes of carrying out the present disclosure have been disclosed, those skilled in the art would recognise that other embodiments for carrying out or practising the present disclosure are also possible.

Throughout the present disclosure, the terms air borne vehicle, air plane and aircraft have been used synonymously. The term “air borne vehicle” refers to a machine specifically designed to navigate and travel through the Earth's atmosphere. It is a vehicle that is capable of achieving and maintaining flight by generating lift through aerodynamic forces. Aircrafts can be classified into different categories based on their design, function, and operating principles. The aircraft comprises at least one of airplane, helicopter, glider, Vertical Take Off and Landing Aircraft (VTOL), and drone.

Throughout the present disclosure the term “Vertical Take Off and Landing Aircraft (VTOL)” refers to an aircraft capable of taking off, hovering, and landing vertically without the need for a runway or a forward airspeed. Unlike conventional fixed-wing aircraft that require a runway for take-off and landing, VTOL aircraft have the ability to ascend and descend vertically, similar to helicopters. VTOL aircraft are advantageous in situations where traditional runway-based take-off and landing are impractical or unavailable. They can operate from confined spaces, remote areas, or even from a moving platform like a ship. Additionally, VTOL capabilities are crucial for military operations, search and rescue missions, and various specialized tasks where vertical flight is essential. However, VTOL aircraft often require more complex engineering and design compared to conventional fixed-wing aircraft, making them challenging and costly to develop.

Regardless of their specific type, all aircraft share fundamental components and systems. These include an airframe (body), wings or rotor systems, control surfaces (such as ailerons and elevators), engines or propulsion systems, landing gear, and various avionics and navigation instruments. These components work together to ensure stability, control, and the ability to navigate through the air.

Throughout the present disclosure, the terms unique navigational input, flight plan, and route have been used synonymously. The term “unique navigational input” refers to a navigational input generated for an airborne vehicle refers to information and guidance provided to enable the air borne vehicle to navigate through the sky along a predetermined path. It encompasses at least one input, system, procedure and/or a combination thereof designed to assist pilots in safely and efficiently reaching their intended destination. The navigational input comprises a set of waypoints that forms a sequential series of positions in three-dimensional space. These waypoints are typically defined by latitude, longitude, and altitude coordinates, and are interconnected to form the flight plan. The flight plan is carefully crafted based on factors such as air traffic control restrictions, airspace regulations, weather conditions, and aircraft performance capabilities.

Furthermore, to accurately follow the generated navigational input, pilots rely on sophisticated avionics systems and instruments. These systems may include an inertial navigation system (INS), global navigation satellite system (GNSS) receivers (such as GPS), and ground-based navigational aids like VOR (VHF Omnidirectional Range) or NDB (Non-Directional Beacon) stations. The air borne vehicle's flight management system (FMS) or flight navigation system (FNS) processes the generated navigational inputs to compute the precise course, heading, and altitude adjustments required to stay on track. Pilots continuously monitor the air borne vehicle's position and progress relative to the generated navigational input using a cockpit display, such as electronic flight displays (EFDs) or multifunction displays (MFDs). These displays provide a visual representation of the aircraft's position overlaid on charts, maps, or synthetic vision systems (SVS), offering real-time situational awareness. In addition to the generated navigational input, pilots must also account for real-time changes in flight conditions. Air traffic control instructions, weather updates, and airspace restrictions may necessitate adjustments to the air borne vehicle's course, altitude, or speed.

The navigational input for the airborne vehicle is a carefully planned and dynamic guidance system that allows pilots to navigate the skies with precision, efficiency, and utmost safety, ensuring a smooth and successful journey to their intended destination.

Throughout the present disclosure, the term “server arrangement” refers to an arrangement of one or more servers that includes one or more processors configured to perform various operations, as described below. The server arrangement relates to a structure and/or module that include programmable and/or non-programmable components configured to store, process and/or share information. Optionally, the server arrangement includes any arrangement of physical or virtual computational entities capable of enhancing information to perform various computational tasks. Furthermore, it should be appreciated that the server arrangement may be both single hardware server and/or plurality of hardware servers operating in a parallel or distributed architecture. In an example, the server arrangement may include components such as memory, a processor, a network adapter and the like, to store, process and/or share information with other computing components, such as user device/user equipment. Optionally, the server arrangement is implemented as a computer program that provides various services (such as database service) to other devices, modules or apparatus.

Throughout the present disclosure, the term “communication network” as used herein includes but not limited to, a cellular network, short-range radio (for example, such as Bluetooth®), Internet, a wireless local area network, and an Infrared Local Area Network, or any combination thereof.

Throughout the present disclosure, the term “application module” refers to a self-contained unit of code that performs a specific functionality. It is typically a modular component that may be integrated into a larger software system or framework. The application module encapsulates related functions, data, and logic, providing a cohesive and reusable unit that promotes modular design principles. The application module is designed to be independent, allowing it to be developed, tested, and maintained separately from other modules.

In the first aspect, embodiments of the present disclosure provide a system for generating the at least one unique navigational input for one or more air-borne vehicle. The system comprises at least one server arrangement which is communicably coupled to an application module via a data communication network. The server arrangement is configured to communicate at least one information to the application module, wherein the application module is also configured to send at least one information back to the server arrangement, as well. The at least one information sent back to the server arrangement by the application module comprises at least one user input received from a user, wherein the application module is configured to receive at least one flight request from the user, and send it back to the server arrangement, and wherein the at least one information which is communicated from the server to the application module comprises full flight data, including the take-off, route path, and emergency exits.

Furthermore, the server arrangement is configured to generate at least one unique navigational input upon receiving the flight request from the user based on at least one factor using an artificial intelligence module. Optionally, the server arrangement is configured to generate the at least one unique navigational input for the air borne vehicles based on the allowed flying zones for the air borne vehicles of the same type. Wherein, the at least one factor comprises: (I) appearance of unknown objects such as but not limited to birds, and/or balloons, and/or unreported aircraft, and/or drones; (ii) at least one area with a high probability of deviation from the generated navigational input, caused by factors, such as but not limited to, traffic congestion and network signal loss; (iii) the specific handling characteristics of the air borne vehicle model in a given situation; (iv) consequences arising from plurality of hazards; (v) analysis of publications about plurality of geographical locations to identify flying zones and/or areas to avoid flying through or flying around; (vi) the expected behaviour of the pilot and/or air borne vehicle based on travel history which affects the nature of the generated navigational input, size of the air borne vehicle, and the level of risk the flight will create for environment, and pilot's ability to meet time windows assigned to each section of their generated navigational input; (vii) weather conditions, wherein the weather condition further comprises: (a) avoiding areas where dangerous weather is expected; (b) predicting expected speed and direction of the wind in order to enable tailwind flying; (viii) predicting the best landing approach. The plurality of hazards comprises, for example there was environmental damage (such as a flood, hurricane, fire) or a major road accident, approaching the hazard area could be dangerous. So the system will generate a unique navigational input (flight route) that will keep distance from the hazard.

Furthermore, the behaviour patterns of the pilot reflects on how skilled the pilot is, and how well his flight will comply with the times of the flight path assigned to him. This helps because the pilot who does not comply with the flight times will deviate from his route and may endanger himself and his surroundings. In this way, the system will also know in advance how to adapt the route to the pilot's abilities.

Furthermore, the system generates the unique navigational input (flight path) by taking into account the skills of the pilot, as well as the tendencies of his performance. This way, the system will be able to efficiently predict what the future position of the aircraft will be at any moment (this is inevitably affected by the skill of the pilot) and also, how dangerous the pilot is and other aircraft routes should be kept away from him. In addition, the system takes into account the same aspect of what that aircraft usually does, either in terms of the specific aircraft and its history, or the general history of this type of aircraft. So by using artificial intelligence the system does the following:

(a). Analyse the behaviour patterns of the pilot (or of the aircraft) that repeat themselves and affect the pilot's ability to fly properly on the flight path assigned to him.

(b). Analyse the behaviour patterns of the pilot (or of the aircraft) in order to know the degree of danger he causes to the environment and how much he should be kept away from other aircraft.

Throughout the present disclosure, the term “artificial intelligence module” refers to the artificial intelligence (AI) module, which is integrated into an aircraft's/air borne vehicle's system to generate at least one unique navigational input, is a software component designed to autonomously generate optimized flight paths for aircraft operations. It leverages AI techniques to analyse various factors and constraints, such as but not limited to weather conditions, airspace regulations, fuel efficiency, aircraft performance, and operational requirements. The AI module utilizes machine learning algorithms and data-driven models to process a wide range of information sources, including weather forecasts, air traffic control data, aircraft performance specifications, and historical flight data. By analysing and understanding this data, the AI module is configured to enable the server arrangement to make informed decisions about the most efficient and safe navigational inputs/routes for the aircraft.

Wherein, the AI module enables the server arrangement for:
(i) Route Optimization: The AI module evaluates multiple potential flight routes and determines the most optimal path based on factors such as fuel consumption, weather conditions, airspace restrictions, and flight time. Furthermore, the AI module evaluates the behaviour history of the pilot, aircraft, and other pilots who flew in these areas and the history of their behaviour.
(ii) Weather Analysis: The AI module analyses current and forecasted weather data to identify potential hazards, turbulence, storms, or other adverse conditions along the proposed routes. The AI module is configured to adjust the generated navigational input to avoid and/or minimize exposure to such conditions.
(iii) Airspace Management: The AI module also configured to take into account the regulations and restrictions imposed by different airspace authorities and adjusts the flight plan accordingly to ensure compliance and avoid conflicts with other aircraft.
(iv) Fuel Efficiency: By considering the aircraft's performance characteristics and the prevailing atmospheric conditions, the AI module is also configured to optimize fuel consumption and reduces emissions by generating and suggesting more efficient navigational input and altitudes.
(v) Real-time Updates: The module continually monitors the flight's progress and dynamically adjusts the generated navigational input as necessary. It can incorporate real-time data on weather changes, traffic congestion, or unforeseen circumstances to ensure the flight remains on the safest and most efficient course.
(vi) Safety Considerations: The AI module also prioritizes safety by considering factors such as but not limited to terrain avoidance, proximity to obstacles, and emergency landing options while generating the navigational input.

Furthermore, the “artificial intelligence module” as used in this disclosures in general refers to a software component and/or system that incorporates plurality of techniques and algorithms to perform specific tasks and/or functions. It is designed to simulate human intelligence and exhibit intelligent behaviour, such as but not limited to problem-solving, decision-making, learning, and perception, within a specific domain and/or application. The AI module comprises of several interconnected components, including data processing and analysis algorithms, machine learning models, knowledge representation structures, and inference engines. These components work together to process input data, learn from it, reason or make predictions, and produce meaningful output.

Furthermore, in the first aspect of the invention Natural Language Processing (NLP) Module is utilised to process the flight request received from the user, using the application module, wherein the flight request received from the user is in natural language format, such as but not limited to English language. The NLP module enables server arrangement to understand, interpret, and generate human language. It involves tasks such as but not limited to speech recognition, text-to-speech synthesis, sentiment analysis, language translation, and chat-bot interactions.

Throughout the present disclosure, the term “Tailwind flying” refers to a situation in aviation where the air borne vehicle experiences a favourable wind blowing from behind, in the same direction as its intended flight path. In tailwind flying the wind aids the air borne vehicle's forward motion, resulting in increased groundspeed. Tailwind during flight of the air borne vehicle effectively reduces the time required to reach its destination. The tailwind provides an additional boost to the air borne vehicle's airspeed, allowing it to cover more ground in a given amount of time compared to flying in still air or facing a headwind (opposite direction wind). Tailwinds can occur naturally due to the movement of atmospheric air masses and/or can be intentionally utilized by pilots when planning flight routes to take advantage of wind patterns. Pilots and flight planners consider wind forecasts and plan routes that maximize the benefits of tailwinds, optimizing fuel efficiency and reducing overall flight duration. Tailwind flying is advantageous as it provides shorter flight times and fuel savings. Furthermore, it's important for pilots to ensure they operate within safe limits and take into account factors like aircraft performance, air traffic control instructions, and any limitations or restrictions associated with specific airspaces or routes. Proper flight planning, including the consideration of winds aloft and careful management of airspeed, is crucial to ensure a safe and efficient flight when encountering tailwind conditions.

Throughout the present disclosure, the term “database arrangement” refers to an arrangement of virtual or physical memory units capable of storing digital data files. Optionally, the database arrangement may be storage systems, such as but not limited to, a relational database such as IBM DB2®, and Oracle 9R. Alternatively, the database arrangement may be a cloud database such as but not limited to, Google cloud®, IBM cloud®, Microsoft Azure®, and so on. The database arrangement may store the received data in a structured or unstructured form or in a combination thereof.

Furthermore, in the first aspect, at least one database arrangement is communicably coupled with the server arrangement and the application module. The database arrangement is configured to store the generated navigational input, generated by the server arrangement. Optionally, the database arrangement is at least one physical memory unit. Optionally, the database arrangement is located in the air borne vehicle, wherein the generated navigational input is locally stored in the database arrangement. This enables for locally storing and accessing the generated navigational input in case of no-network or low-network connectivity without any data loss there between. Locally storing of the generated navigational input in the database arrangement not only ensures the in-flight safety of the air borne vehicles during the flight, but also ensures the safety of the air borne vehicles on the ground as well. The air borne vehicle's pilot can continue to fly the vehicle without interruption, even in situations where the network connection is lost. The air borne vehicle's pilot can deal with emergency situations, even when disconnected from the communication network, and carefully land the air borne vehicle on one of the pre-assigned emergency exit routes.

Furthermore, the server arrangement is configured to predict at least one emergency exit input, based on the at least one parameter. Optionally, the server arrangement is configured to predict the best emergency exits from the generated navigational input.

Optionally, the server arrangement is configured to pre-allocate emergency landing routes that will be reserved and saved in advance (even before departure) just like the generated navigational input itself.

Optionally, the server arrangement is configured to predict the frequency of the emergency exits suitable for the generated navigational input, considering different parameters, such as but not limited to the speed in each section of the generated navigational input.

Optionally, the server arrangement is configured to ensure a safe distance between the emergency exit routes and nearby air routes.

The term “emergency exit input” and emergency exit routes” are used synonymously throughout the present disclosure. Throughout the present disclosure, the term “emergency exit input” refers to an alternative landing sites and/or procedures that are followed when an aircraft encounters an emergency situation that necessitates an immediate landing. The emergency exit routes are designed to provide options for the pilot to safely bring the aircraft down in a controlled manner, minimizing risks and ensuring the safety of passengers, crew and the air borne vehicle.

Furthermore, the server arrangement is configured to iteratively generate the unique navigational input based on the at least one factor to predict the emergency exit input having optimized combination of safety and speed. Wherein the at least one factor (i) appearance of unknown objects such as but not limited to birds, and/or balloons, and/or unreported aircraft, and/or drones; (ii) at least one area with a high probability of deviation from the generated navigational input, caused by factors, such as but not limited to, traffic congestion and network signal loss; (iii) the specific handling characteristics of the air borne vehicle model in a given situation; (iv) consequences arising from plurality of hazards; (v) analysis of publications about plurality of geographical locations to identify flying zones and/or areas to avoid flying through or flying around; (vi) the expected behaviour of the pilot and/or air borne vehicle based on travel history which affects the nature of the generated navigational input, size of the air borne vehicle, and the level of risk the flight will create for environment, and pilot's ability to meet time windows assigned to each section of their generated navigational input; (vii) weather conditions, wherein the weather condition further comprises: (a) avoiding areas where dangerous weather is expected; (b) predicting expected speed and direction of the wind in order to enable tailwind flying; (viii) predicting the best landing approach.

Furthermore, the server arrangement is configured to respond to the at least one flight request received from the user, by sending the at least one generated unique navigational input to the application module.

Optionally, the server arrangement is configured to generate a special unique navigational input for the air borne vehicles which requests a safer flight route. The server arrangement is configured special flight route for the air borne vehicles requesting a security-sensitive flight routes. For example, if an important person and/or cargo is being flown, the server arrangement will calculate the fastest route and perform a special exclusion of other nearby flight routes. However, the aforementioned special exclusion is subjected to licensed pilot's discretion, and approval from a third party supervisor.

Optionally, the server arrangement is configured to present a clear and straightforward navigation instructions to the pilot of air borne vehicle (non-autonomous), such as but not limited to, raise it to a height of 200 feet, fly at a speed of 100 knots in the direction of 070, and so on.

Optionally, the server arrangement is configured to transmit data, including the generated unique navigational input, to an autonomous air-borne vehicle in advance. Optionally, the server arrangement will continue to update the generated navigational input in real time according to changes in air traffic. Optionally, the updated the generated navigational input is subject to the third party's approval.

Furthermore, in case an emergency landing is required, the server arrangement will transmit an encrypted trigger that will cause the air borne vehicle to make a safe emergency landing. The server arrangement will transmit the encrypted trigger to enable the air borne vehicle to make a safe emergency landing, wherein in an embodiment the air borne vehicle is an autonomous vehicle.

For example: If new danger is expected for the air borne vehicle, the system will send an instruction to carry out an emergency landing in an encrypted manner. The landing instruction will include a unique digital signature that can only be generated by the system located on the server. The digital signature will be created by encrypting the landing instruction with a private key that is only known to the server. When the landing instruction is received by the airborne vehicle, the on application of the airborne vehicle will decrypt the instruction using the public key that is provided by the server. The application will then check the digital signature to ensure that the landing instruction is genuine and has not been tampered with. If the digital signature is valid, the application will execute the landing instruction and the air borne vehicle will land at the designated emergency exit.

Furthermore, a strong authentication mechanism is implemented to ensure that only authorized users can access the system. This could include a combination of password-based authentication, biometric authentication, or multi-factor authentication. The communication between the server and the autonomous pilot tool will be encrypted using a secure cipher, such as AES (Advanced Encryption Standard), to prevent eavesdropping and tampering by hackers. Additionally, hardware acceleration can be used to speed up the encryption and decryption process, ensuring that the system operates efficiently. This process ensures that the landing instruction cannot be faked by unauthorized parties and provides an additional layer of security to the air traffic control system.

Optionally, in an another aspect of the invention the server arrangement is configured to predict at least one landing approach, as the unique navigational input for the at least one air-borne vehicle, using the artificial intelligence module, wherein the at least one landing approach is a part of the generated unique navigational input for the air borne vehicle, and wherein the at least one landing approach enables the air borne vehicle to execute a safe landing.

Optionally, in an another aspect of the invention the server arrangement is configured to continuously monitor navigational data of the plurality of air-borne vehicles, wherein the server arrangement is configured to maintain the plurality of air-borne vehicles at a safe distance from each other. The continuous monitoring of the navigational data of the plurality of air-borne vehicles ensures the time-efficient identification of the changes in the navigational data of air borne vehicles, which are potentially fatal for air borne vehicles. Thus, it ensures the safety of the passengers, crew and air borne vehicles.

Optionally, in an another aspect of the invention the server arrangement is configured to identify the unexpected change in the navigational data of the plurality of air-borne vehicles, and iteratively alter the navigational input for the at least one air-borne vehicle to generate a safe navigational input for the at least one air-borne vehicle, in real time.

Optionally, in an another aspect of the invention the server arrangement is configured to identify the at least one air-borne vehicle which is disconnected from the communication network, wherein the server arrangement is configured to alter the generated navigational input for the at-least one air-borne vehicle which is connected to the communication network, such that the disconnected air-borne vehicle will continue to use their current navigational input without clashing with other air-borne vehicles. The server arrangement identifies the air-borne vehicle which is disconnected from the communication network due to permanent or temporary loss in network connectivity. In one aspect of the present invention, the server arrangement is configured to send and receive at least one data packet from the at least one air borne vehicle, at regular interval of time. Air traffic control (ATC) primarily uses radar and transponder systems to track and identify the air borne vehicle. ATC uses radar systems, such as primary surveillance radar (PSR) and secondary surveillance radar (SSR), to detect and track aircraft. PSR utilizes radio waves to detect the presence of aircraft and determine their position and heading. SSR relies on radar signals sent from the ground and received by an aircraft's transponder. The transponder replies with information such as the aircraft's identification code (squawk code) and altitude, allowing ATC to identify and track the aircraft more accurately. Furthermore, airborne vehicle is equipped with a transponder. The transponder communicates with the radar systems used by ATC. The radar system sends a signal to an air borne vehicle's transponder, and it triggers a response from the transponder that includes the air borne vehicle's identification code (squawk code), altitude, and other pertinent information. This information is then displayed to the air traffic controller, enabling them to identify the air borne vehicle, and if its connected to a network or not.

Throughout the present disclosure, the term “database arrangement” refers to a device that receives and responds to specific signals or requests from ground-based radar systems. Transponder is important in aviation for identification, surveillance, and communication purposes. The transponder provides a unique identification code for the aircraft, known as the squawk code or Mode A code. The squawk code is assigned by air traffic control and allows the aircraft to be easily identified on radar displays. The transponder enhances surveillance capabilities by providing additional information about the air borne vehicle's altitude. This information is known as the Mode C or altitude encoding feature. It allows air traffic controllers to have a more accurate understanding of the aircraft's position and altitude. The Transponders also ensures the collision avoidance, such as TCAS (Traffic Collision Avoidance System). TCAS uses transponder signals to detect other nearby aircraft and provides advisories or resolutions to prevent potential collisions. The transponder also enables the communication. The air traffic controllers send specific requests and/or instructions to the airborne vehicle via the transponder. For example, controllers may instruct an airborne vehicle to squawk a particular code or activate specific modes on the transponder for specific purposes. The transponder operates on specific frequencies, such as 1030 MHz for receiving signals from ground-based radar and 1090 MHz for transmitting responses back to the radar systems.

Furthermore, upon identifying the air borne vehicle which is disconnected from the communication network, the server arrangement alters the generated navigational input for the air-borne vehicle which is connected to the communication network, such that the disconnected air-borne vehicle will continue to use their current navigational input without clashing with other air-borne vehicles. The server arrangement ensures that air borne vehicles (both, which are connected to the communication network, and which are not connected to the communication network) continue to fly safely. It also ensures the safety of the air borne vehicles, and eradicates the unfortunate possibility of clash of air borne vehicles.

Optionally, in an another aspect of the invention the server arrangement is communicably coupled with a supervision module via the data communication network, wherein the supervision module is configured to identify at last one anomaly pertaining to the at least one air-borne vehicle which requires at least one input from another user, and wherein the supervision module is configured to analyse the navigational data of at least one air-borne vehicle, and identify the at least one anomaly using an artificial intelligence module, in real time. The supervision module utilizes the expertise and vigilance of another user, such as but not limited to the air traffic control (ATC) employees, managing and overlooking the air traffic, ground staff, another air borne vehicle which still air borne.

The supervision module identifies at last one anomaly pertaining to the air-borne vehicle, such as but limited sudden, unexpected change in the flight path of the air borne vehicle, and/or sudden, unexpected change in the altitude of the air borne vehicle, and/or sudden, unexpected change in the pitch and roll of the air borne vehicle. Furthermore, the supervision module conveys the identified anomaly of the air-borne vehicle to the user for his supervision and intervention.

Furthermore, the supervision module analyses the navigational data of the air-borne vehicle, and identifies the anomaly for which user's supervision and intervention is needed, using the artificial intelligence module, in real time. The artificial intelligence module, such as but not limited to Machine Learning (ML), Deep Learning (DL), Reinforcement Learning (RL), Natural Language Processing (NLP), Computer Vision, Data Fusion, and optimization Algorithms. The identification of anomaly in the air-borne vehicle which requires input from the user, using the artificial intelligence, ensures the real-time anomaly identification, which might cause a catastrophic air crash between the air borne vehicles. This ensures the safety of the air borne vehicles during the flight.

Optionally, in an another aspect of the invention the server arrangement is configured to identify at least one fuel station based on the generated unique navigational input for the one or more air-borne vehicle, wherein the server arrangement utilizes the artificial intelligence module to identify the nearest fuel station to ensure that the one or more air-borne vehicle receives fuel timely, and wherein the server arrangement is configured to manage at least one in-air waiting areas, based on congestion of air-traffic on the identified at least one fuel station. The server arrangement ensures that to provide plurality of available fuel stations to the air borne vehicle for the timely refuelling of the air borne vehicle. This ensures that air borne vehicle does not run out of the fuel during flight. Furthermore, the available fuel stations are identified using the artificial intelligence, utilizing the air borne vehicle's current position, destination, and navigational input (path) being followed by the air borne vehicle during the flight. Furthermore, the server arrangement also manages plurality of in-air waiting areas, based on congestion of air-traffic on the identified fuel station.

Furthermore, the server arrangement is also configured to facilitate the aerial fueling of the one or more air-borne vehicle based on the generated unique navigational input. The server arrangement analyses the unique navigational input for the air borne vehicle, current position of the air borne vehicle, and desired destination of the air borne vehicle and location of the available air borne vehicle configured for aerial refuelling. Based on this analysis the unique navigational input of the air borne vehicle and the location of the air borne vehicle configured for aerial refuelling, the server arrangement modifies the unique navigational input of the air borne vehicle to meet the air borne vehicle configured for the aerial refuelling. The server arrangement may also modify the navigational input of the air borne vehicle configured for the aerial refuelling to meet the air borne vehicle which is needed to be refueled. Optionally, the server arrangement is also is configured to execute the aerial recharging of at least one electric air borne vehicle. The Aerial recharging of electric air-borne vehicles (in-flight charging), aims to extend the flight range and endurance of electric aircraft by replenishing their batteries while they are in the air. The in-flight charging is particularly relevant for electric drones, electric vertical take-off and landing (eVTOL) aircraft, and other electric air-borne vehicles that operate on batteries and have limited flight times due to energy constraints.

The aerial recharging process typically involves the following steps:
(i) Ground-based Charging Infrastructure: a network of ground-based charging stations needs to be strategically located across the operating area. These charging stations are equipped with high-power charging systems capable of transmitting electricity wirelessly to the airborne vehicle.
(ii) Communication and Positioning: The electric air-borne vehicle have communication systems and positioning technology to establish a connection with the ground-based charging stations. This enables the vehicle to receive real-time data about the charging station's location, availability, and power capacity.
(iii) Alignment and Connection: During flight, the vehicle navigates to the vicinity of a charging station. To initiate the aerial recharging process, the vehicle needs to align itself with the charging station and establish a stable connection.
(iv) Continuous Operation: The aerial recharging process allows the electric air-borne vehicle to continue its flight while receiving a continuous supply of electricity. This enables it to extend its flight range and perform longer missions without the need for frequent landings to recharge.

Optionally, in an another aspect of the invention the server arrangement is configured to identify at least one designated waiting area on ground for the one or more air-borne vehicle which were not able to perform aerial refuelling. The server arrangement identifies the designated waiting area on ground for the air-borne vehicle in advance, for the air borne vehicle which failed to perform the aerial refuelling, by using the artificial intelligence, in real time. This ensures that even if the air borne vehicle fails to refuel aerially, the waiting area for such air borne vehicle are identifying in advance.

Optionally, in an another aspect of the invention the server arrangement is to create at least one alert to point-out deviations of the one or more air-borne vehicle from the generated at least one unique navigational input to a third party, by using the artificial intelligence module, wherein the created at least one alert comprises at least one of: a data pack of relevant information, a potential flight path, and an emergency communication. The server arrangement continuously and meticulously monitors the air traffic data of the air borne vehicle, and is capable of identifying the any anomaly or deviation of the air borne vehicle form the designated unique navigational input by using the artificial intelligence. The server arrangement utilizes an alert to point out any such deviation to the third party (such as ATC, ground staff, and another air borne vehicle). This enables the third party to communicate with the deviated air borne vehicle manually, to rectify the deviation and/or get a justification of the deviation in order to ensure the safety of all the air borne vehicles.

### DETAILED DESCRIPTION OF THE DRAWINGS

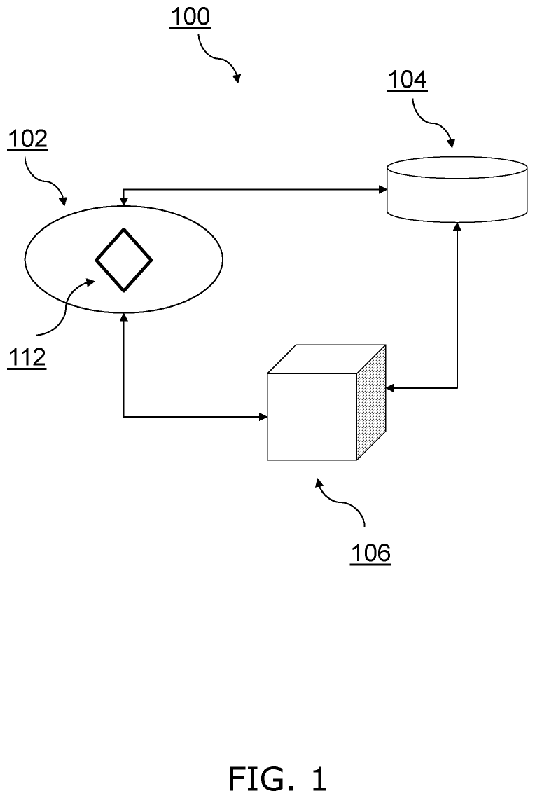

Referring now to the drawings, particularly by their reference numbers, FIG. 1 is a schematic illustration of a system (100) for generating at least one unique navigational input for one or more air-borne vehicle. The system (100) comprises, a server arrangement (102) communicably coupled to an application module (104) via a data communication network, and database arrangement (106) communicably coupled with the server arrangement (102) and the application module (104). The server arrangement (102) is configured to receive at least one flight request from at least one user via the application module (104); generate at least one unique navigational input, upon receiving the at least one flight request from the user, based on at least one factor using an artificial intelligence module (112). The server arrangement (102) is configured to predict at least one emergency exit input, based on the at least one parameter. The server arrangement (102) is configured to iteratively generate unique navigational input based on the at least one factor, to predict the emergency exit input having optimized combination of safety and speed. The server arrangement (102) is configured to respond to at least one flight request received from the at least one user, by sending the at least one generated unique navigational input to the application module (104).

FIG. 1 is merely an example, which should not unduly limit the scope of the claims herein. A person skilled in the art will recognize many variations, alternatives, and modifications of embodiments of the present disclosure.

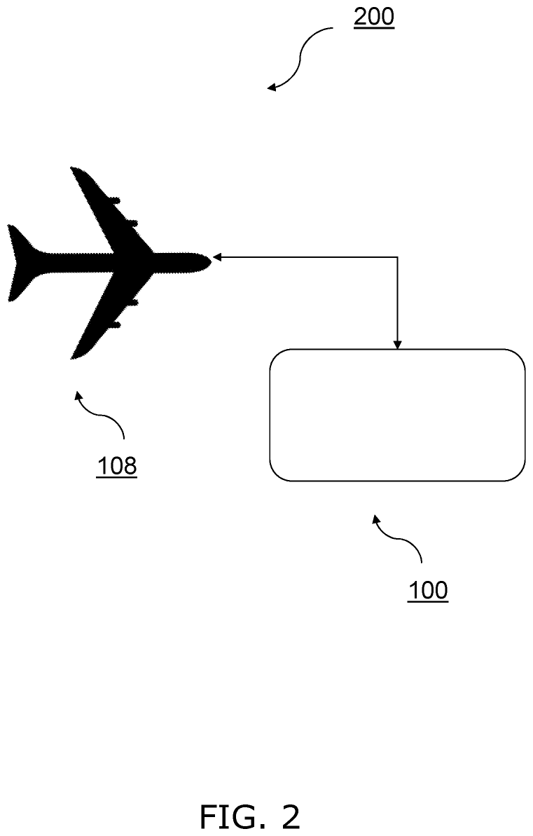

FIG. 2 is a schematic illustration of an arrangement (200) comprising the system (100) for generating at least one unique navigational input for one or more air-borne vehicle in communication with an airborne vehicle (108). FIG. 2 is merely an example, which should not unduly limit the scope of the claims herein. A person skilled in the art will recognize many variations, alternatives, and modifications of embodiments of the present disclosure.

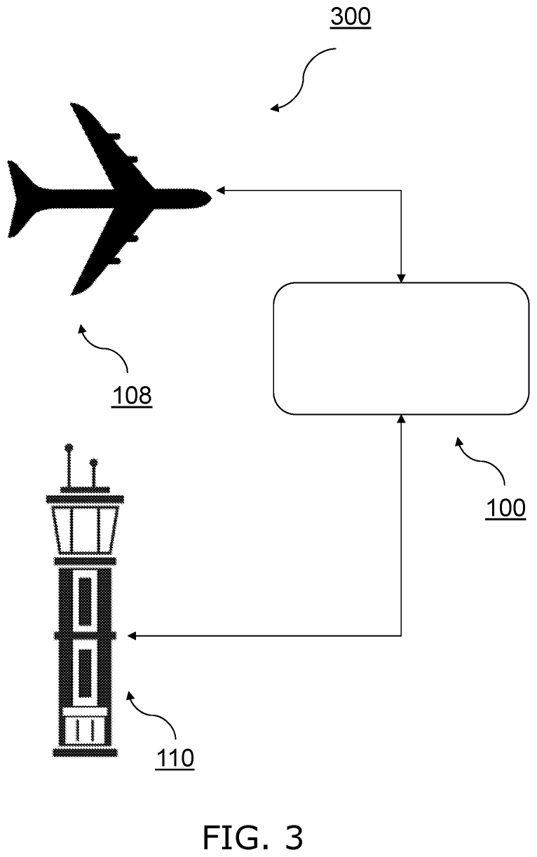

FIG. 3 is a schematic illustration of an arrangement (300) comprising the system (100) for generating at least one unique navigational input for one or more air-borne vehicle in communication with an airborne vehicle (108), and in communication with a third party (air traffic control) (110). FIG. 3 is merely an example, which should not unduly limit the scope of the claims herein. A person skilled in the art will recognize many variations, alternatives, and modifications of embodiments of the present disclosure.

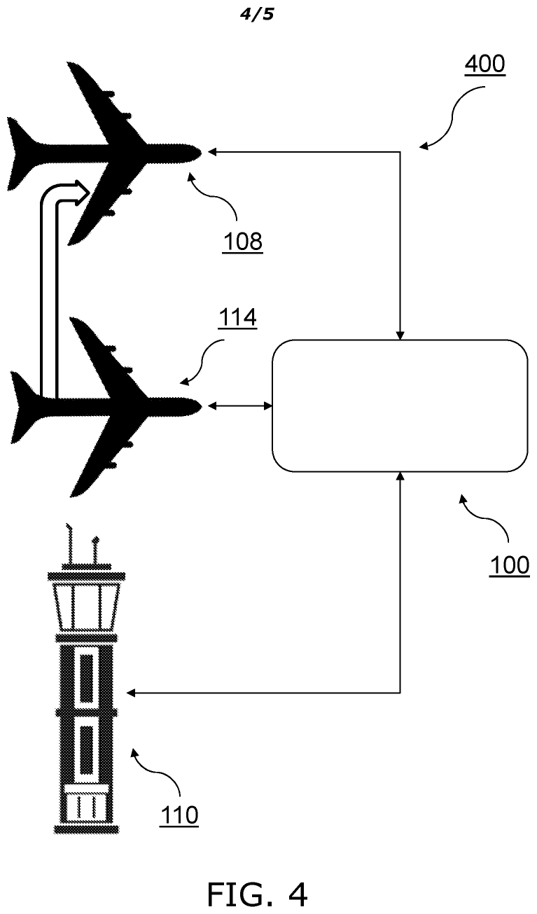

FIG. 4 is a schematic illustration of an arrangement (400) comprising the system (100) for generating at least one unique navigational input for one or more air-borne vehicle in communication with the airborne vehicle (108) and in communication with the third party (air traffic control) (110), and in communication with an air borne vehicle configured for aerial refuelling (114). FIG. 4 is merely an example, which should not unduly limit the scope of the claims herein. A person skilled in the art will recognize many variations, alternatives, and modifications of embodiments of the present disclosure.

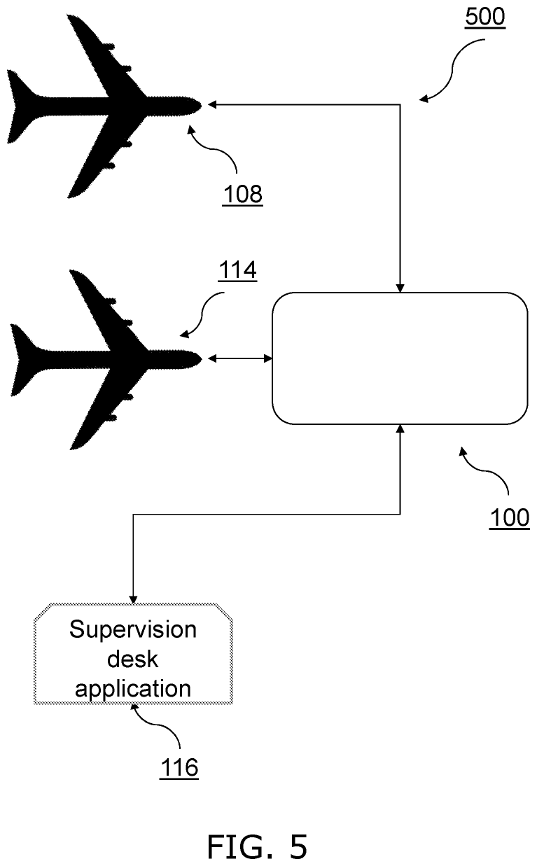

FIG. 5 is a schematic illustration of an arrangement (500) comprising the system (100) for generating at least one unique navigational input for one or more air-borne vehicle in communication with the airborne vehicle (108) and in communication with the Supervision Desk Application (116). FIG. 5 is merely an example, which should not unduly limit the scope of the claims herein. A person skilled in the art will recognize many variations, alternatives, and modifications of embodiments of the present disclosure.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

We claim:

1. A system for generating at least one unique navigational input for one or more air-borne vehicle, wherein the system comprises:
at least one server arrangement communicably coupled to an application module via a data communication network;
at least one database arrangement communicably coupled with the server arrangement and the application module;
wherein the server arrangement is configured to:
receive at least one flight request from at least one user via the application module;
generate at least one unique navigational input, upon receiving the at least one flight request from the user, based on at least one factor using an artificial intelligence module;
wherein the server arrangement is configured to predict at least one emergency exit input, based on the at least one parameter,
wherein the server arrangement is configured to iteratively generate unique navigational input based on the at least one factor, to predict the emergency exit input having optimized combination of safety and speed, and
wherein the server arrangement is configured to respond to at least one flight request received from the at least one user, by sending the at least one generated unique navigational input to the application module.

2. The system of claim 1, wherein the server arrangement is configured to predict at least one landing approach, as the unique navigational input for the at least one air-borne vehicle, using the artificial intelligence module.

3. The system of claim 1, wherein the application module is configured to locally store the generated unique navigational input in the database arrangement, and wherein the user has the access of the locally stored generated unique navigational input in case of lack of the communication network.

4. The system of claim 1, wherein the server arrangement is configured to update the generated navigational input in real time, based on air-traffic data.

5. The system of claim 1, wherein the server arrangement is configured to continuously monitor navigational data of the plurality of air-borne vehicles, wherein the server arrangement is configured to maintain the plurality of air-borne vehicles at a safe distance from each other.

6. The system of claim 5, wherein the server arrangement is configured to identify the unexpected change in the navigational data of the plurality of air-borne vehicles, and iteratively alter the navigational input for the at least one air-borne vehicle to generate a safe navigational input for the at least one air-borne vehicle, in real time.

7. The system of claim 6, wherein the server arrangement is configured to identify the at least one air-borne vehicle which is disconnected from the communication network, wherein the server arrangement is configured to alter the generated navigational input for the at-least one air-borne vehicle which is connected to the communication network, such that the disconnected air-borne vehicle will continue to use their current navigational input without clashing with other air-borne vehicles.

8. The system of claim 1, wherein the server arrangement is communicably coupled with a supervision module via the data communication network, wherein the supervision module is configured to identify at last one anomaly pertaining to the at least one air-borne vehicle which requires at least one input from another user, and wherein the supervision module is configured to analyse the navigational data of at least one air-borne vehicle, and identify the at least one anomaly using the artificial intelligence module, in real time.

9. The system of claim 1, wherein the server arrangement is configured to identify at least one fuel station based on the generated unique navigational input for the one or more air-borne vehicle, wherein the server arrangement utilizes the artificial intelligence module to identify the nearest fuel station to ensure that the one or more air-borne vehicle receives fuel timely, and wherein the server arrangement is configured to manage at least one in-air waiting areas, based on congestion of air-traffic on the identified at least one fuel station.

10. The system of claim 9, wherein the server arrangement is configured to facilitate the aerial fueling of the one or more air-borne vehicle based on the generated unique navigational input.

11. The system of claim 10, wherein the server arrangement is configured to identify at least one designated waiting area on ground for the one or more air-borne vehicle which were not able to perform aerial refuelling.

12. The system of claim 1, wherein the server arrangement is configured to create at least one alert to point-out deviations of the one or more air-borne vehicle from the generated at least one unique navigational input to a third party, by using the artificial intelligence module, wherein the created at least one alert comprises at least one of: a data pack of relevant information, a potential flight path, and an emergency communication.
